(19) United States
(12) Patent Application Publication
(10) Pub. No.: US 2026/0274045 A1
(43) Pub. Date: Sep. 17, 2026

(54) UNIT COOLER

(71) Applicant: KABUSHIKI KAISHA TOYOTA JIDOSHOKKI, Aichi (JP)

(72) Inventors: Ryota WATANABE, Aichi (JP); Hisaya KONDO, Aichi (JP); Kenji YAMAMOTO, Aichi (JP); Kengo SAKAKIBARA, Aichi (JP); Satoru SHIMADA, Aichi (JP)

(73) Assignee: KABUSHIKI KAISHA TOYOTA JIDOSHOKKI, Aichi (JP)

(21) Appl. No.: 19/168,093

(22) PCT Filed: Jan. 18, 2024
(86) PCT No.: PCT/JP2024/001254

§ 371 Date: Sep. 23, 2025

(30) Foreign Application Priority Data
Mar. 28, 2023 (JP) 2023-051865

(51) Int. Cl. B60H 1/32; B60H 1/00

(52) U.S. Cl. CPC B60H 1/3229; B60H 1/00357; B60H 1/00428; B60H 2001/3286

(57) ABSTRACT

A unit cooler includes a housing and an air conditioner cooling air and supplying the air to an outside of the housing. The housing has a base plate, an under cover, a top cover that is fixed to the under cover, and an upper plate. The air conditioner has an electric compressor, a condenser, a decompression device, an evaporator, a pipe, a first fan, and a second fan. The first fan and the second fan are disposed between the base plate and the upper plate and fixed to the base plate and the upper plate. The electric compressor is disposed between the base plate and the upper plate and between the first fan and the second fan.

### TECHNICAL FIELD

The present invention relates to a unit cooler.

### BACKGROUND ART

A conventional unit cooler is disclosed in Patent Literature 1. This unit cooler is used in an industrial vehicle such as a forklift truck, which has a power supply.

This unit cooler in Patent Literature 1 includes a housing and an air conditioner that is accommodated in the housing. The air conditioner has an electric compressor, a condenser, a decompression device, an evaporator, and a control device and forms a refrigeration cycle. The evaporator has a discharge duct. The housing has a first cover in which the electric compressor, the condenser, the decompression device, and the evaporator are accommodated, a second cover in which the control device is accommodated, an attachment plate, and a flat plate. The first cover in which the electric compressor, the condenser, the decompression device, and the evaporator are accommodated and the second cover in which the control device is accommodated are fixed to the attachment plate with bolts. The flat plate is fixed to the industrial vehicle with the bolts. Anti-vibration rubber is provided between the attachment plate and the flat plate, and the attachment plate, the anti-vibration rubber, and the flat plate are fixed with the bolts.

In this unit cooler, for example, in an industrial vehicle that does not have as many means for reducing vibrations as a passenger car, the electric compressor of the air conditioner is operated by a power supply to cool air, and the cooled air is supplied to an outside of the housing through the discharge duct. During this operation, the anti-vibration rubber suppresses that the vibrations while the industrial vehicle travels or operates are transmitted to the electric compressor or the like in the first cover and the control device in the second cover to reduce their failures. The anti-vibration rubber also contributes to quietness by absorbing the vibrations of the electric compressor.

### CITATION LIST

### Patent Literature

Patent Literature 1: Japanese Patent Application Publication No. H07-083464

### SUMMARY OF INVENTION

### Technical Problem

However, in the above-described conventional unit cooler, the air conditioner is only fixed to the attachment plate through the first cover and the second cover, so that the air conditioner is likely to vibrate. In particular, a pipe of the air conditioner is sensitive to vibration because the pipe is joined to the electric compressor or the like. Accordingly, it is desirable that vibration resistance and impact resistance of the unit cooler are improved.

The present invention is made in view of the conventional circumstances described above and is directed to providing a unit cooler that may supply cold air to an outside of the housing and that is superior in vibration resistance and impact resistance.

### Solution to Problem

A unit cooler of the present invention includes: a housing; and an air conditioner that is accommodated in the housing and is provided with a refrigeration cycle, the air conditioner cooling air and supplying the air to the outside of the housing. The unit cooler is characterized in that the housing has a base plate on which the air conditioner is mounted, an under cover that is disposed under the base plate, a top cover that is fixed to the under cover and surrounds the air conditioner together with the under cover, and an upper plate that is disposed between the top cover and the base plate. The air conditioner has an electric compressor, a condenser, a decompression device, an evaporator, a pipe through which a refrigerant flows, a first fan that sends air to the condenser, and a second fan that sends air to the evaporator. The first fan and the second fan are disposed between the base plate and the upper plate and fixed to the base plate and the upper plate. The electric compressor is disposed between the base plate and the upper plate and between the first fan and the second fan.

In the unit cooler of the present invention, the air conditioner forms a refrigeration cycle and cools air and supplies the air to the outside of the housing.

Also, in this unit cooler, the housing has the base plate and the upper plate. The first fan and the second fan of the air conditioner are arranged between the base plate and the upper plate and fixed to the base plate and the upper plate. The electric compressor of the air conditioner is disposed between the base plate and the upper plate and between the first fan and the second fan. Thus, the air conditioner is formed integrally, so that the air conditioner is less likely to vibrate while a moving body such as the industrial vehicle travels or operates, for example.

Thus, the unit cooler of the present invention may supply the cold air to the outside of the housing and is superior in vibration resistance and the impact resistance.

Preferably, the electric compressor and the base plate are fixed with a fastening member, a first collar is disposed between the electric compressor and the upper plate in contact with the electric compressor and the upper plate, and the first collar is positioned on an extension of a center of gravity of the electric compressor. In this case, the structure integrates more closely.

In a case where the air conditioner has an accumulator, preferably, the accumulator and the base plate are fixed with the fastening member, a second collar is disposed between the accumulator and the upper plate in contact with the accumulator and the upper plate, and the second collar is positioned on an extension of a center of gravity of the accumulator. In this case, the structure integrates more closely.

The housing may have a first case in which the first fan is accommodated and a second case in which the second fan is accommodated, the first case and the second case being made of metal. Preferably, the first fan adjacent to the condenser is fixed to one ends of the base plate and the upper plate through the first case, and the second fan adjacent to the evaporator is fixed to the other ends of the base plate and the upper plate through the second case. Preferably, the upper plate is located oppose to the base plate across the first fan and the second fan, and the base plate and the under cover are fixed with a fastening member. The fastening member includes a pair of first fastening members that is disposed with the first fan interposed between the first fastening members and a pair of second fastening members that is disposed with the second fan interposed between the second fastening members. Preferably, the electric compressor is disposed at a position that is overlapped with an intersection point of diagonal lines connecting the first fastening members and the second fastening members. In this case, the electric compressor that is likely to be most massive in the air conditioner is evenly supported by the four fastening members, so that vibrations of the electric compressor are easily suppressed.

### Advantageous Effects of Invention

The unit cooler of the present invention may supply the cold air to the outside of the housing and is superior in vibration resistance and impact resistance.

### BRIEF DESCRIPTION OF DRAWINGS

FIG. 1 is a side view illustrating a forklift truck on which a unit cooler according to an embodiment is mounted.

FIG. 2 is an exploded perspective view illustrating the unit cooler according to the embodiment.

FIG. 3 is a plan view illustrating a state in which a top cover and an upper plate are removed from the unit cooler according to the embodiment.

FIG. 4 is a cross-sectional view illustrating a structure and an under cover in the unit cooler according to the embodiment.

FIG. 5 is a cross-sectional view illustrating a fastening member in the unit cooler according to the embodiment.

FIG. 6 is an enlarged cross-sectional view illustrating an attaching portion to a forklift truck in the unit cooler according to the embodiment.

FIG. 7 is a plan view illustrating a headguard and the unit cooler according to the embodiment in another forklift truck.

FIG. 8 is a perspective view illustrating the headguard and the unit cooler in the forklift truck of FIG. 7 as viewed from a front of them.

FIG. 9 is a plan view similar to FIG. 7 in a case where a mounted position of the unit cooler according to the embodiment is changed.

FIG. 10 is a plan view similar to FIG. 7 in a case where the mounted position of the unit cooler according to the embodiment is further changed.

### DESCRIPTION OF EMBODIMENTS

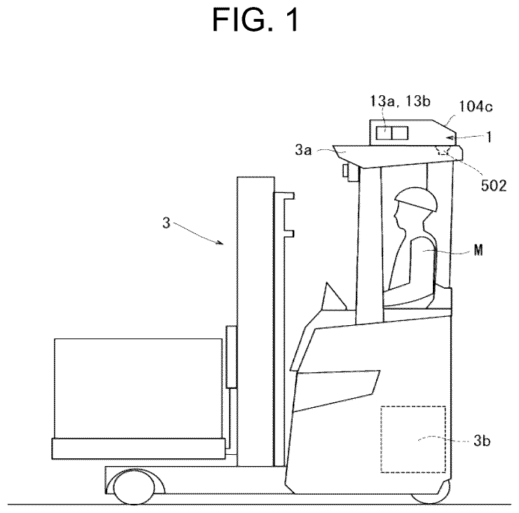

The following will describe an embodiment according to the present invention with reference to accompanying drawings. As illustrated in FIG. 1, a unit cooler 1 of the embodiment is fixed to a headguard 3a of a reach-type electric forklift truck 3 as the industrial vehicle. The forklift truck 3 has a battery 3b as the power source. When a driver M operates the forklift truck 3, the forklift truck 3 travels and performs cargo handling work by power supplied from the battery 3b.

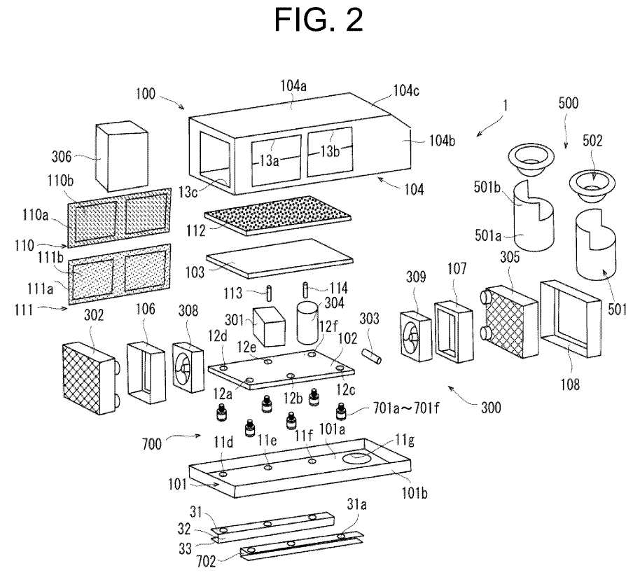

This unit cooler 1, as illustrated in FIG. 2, includes a housing 100, an air conditioner 300, and a cold air guiding portion 500. The housing 100 has an under cover 101, a base plate 102, an upper plate 103, and a top cover 104.

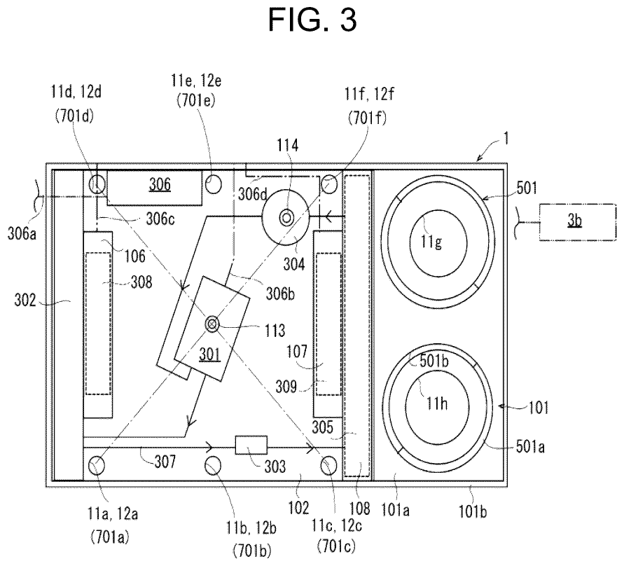

The under cover 101 is made of metal. The under cover 101 includes a bottom plate 101a formed in a rectangular shape and a peripheral wall 101b extending upward from four sides of the bottom plate 101a and connected to each other. Six bolt holes 11a to 11f and two ventilation ports 11g, 11h extend through the bottom plate 101a, as illustrated in FIG. 3. In FIG. 3, in a left area of the bottom plate 101a relative to a center thereof, three of the bolt holes 11a to 11f are formed along one long side of the bottom plate 101a and the remaining three of the bolt holes 11a to 11f are formed along the other long side of the bottom plate 101a. The ventilation ports 11g, 11h are formed on upper and lower portions of the bottom plate 101a in a right area of the bottom plate 101a. The three bolt holes 11a to 11c along the one long side are arranged at regular intervals, and the three bolt holes 11d to 11f along the other long side are also arranged at regular intervals. Note that the bolt hole 11b may be located close to the bolt hole 11a or the bolt hole 11c, and the bolt hole 11e may be located close to the bolt hole 11d or the bolt hole 11f.

The base plate 102 is made of metal. As illustrated in FIG. 2, the base plate 102 is a flat plate formed in a rectangular shape whose long sides are shorter than those of the bottom plate 101a of the under cover 101. Six bolt holes 12a to 12f, which are aligned with the bolt holes 11a to 11f of the under cover 101, extend through the base plate 102. In FIG. 3, three of the bolt holes 12a to 12f are formed along one long side of the base plate 102 and the remaining three of the bolt holes 12a to 12f are formed along the other long side of the base plate 102. A plurality of bolt holes, which is not illustrated, extends through the base plate 102 and is used for fixing a first case 106, an electric compressor 301, an accumulator 304, a second case 107, and a third case 108, which will be described later.

The upper plate 103 is made of metal. As illustrated in FIG. 2, the upper plate 103 is also a flat plate formed in a rectangular shape. The upper plate 103 is disposed between the top cover 104 and the base plate 102. The upper plate 103 does not have bolt holes such as the bolt holes 12a to 12f of the base plate 102. A plurality of bolt holes, which is not illustrated, extends through the upper plate 103 and is used for fixing the first case 106 and the second case 107, which will be described later.

The top cover 104 is made of metal. The top cover 104 has a top plate 104a formed in a rectangular shape, an inclined plate 104c inclining downwards from one end of the top plate 104a, and a peripheral wall 104b extending downwards from three sides of the inclined plate 104c and from three sides of the top plate 104a and connected to each other. The top plate 104a is thicker than the bottom plate 101a of the under cover 101 by the thickness of the top cover 104. The top cover 104 is fixed to the under cover 101 with bolts, which are not illustrated.

The peripheral wall 104b of the top cover 104 has two suction ports 13a, 13b located in one long side of the top plate 104a and a heat releasing port 13c located in one short side of the top plate 104a adjacently to the suction port 13a. A first filter 110 and a second filter 111 are attachable to the suction ports 13a, 13b. The heat releasing port 13c is located opposite to the inclined plate 104c across the top plate 104a.

The first filter 110 includes a first frame 110a that is fixed to the peripheral wall 104b of the top cover 104 and a metal mesh 110b. Two openings, which are aligned with the suction ports 13a, 13b, extend through the first frame 110a. The metal mesh 110b is fixed to the first frame 110a so as to cover both the openings.

The second filter 111 includes a second frame 111a that is fixed to the peripheral wall 104b of the top cover 104 and a sponge 111b. Two openings, which are aligned with the suction ports 13a, 13b, extend through the second frame 111a. The sponge 111b is removably attached to the second frame 111a so as to cover both the openings. The first filter 110 and the second filter 111 are also a part of the housing 100.

The air conditioner 300 has the electric compressor 301, a condenser 302, an expansion valve 303, the accumulator 304, an evaporator 305, and a control device 306. The expansion valve 303 corresponds to a decompression device. As illustrated in FIG. 3, the electric compressor 301, the condenser 302, the expansion valve 303, the evaporator 305, and the accumulator 304 are connected in this order by pipes 307 and they form a refrigeration cycle through which a refrigerant circulates. The condenser 302 and the evaporator 305 are the same rectangular parallelepiped shape. A first fan 308 is disposed on the condenser 302 near the electric compressor 301 and a second fan 309 is disposed on the evaporator 305 near the accumulator 304. The second fan 309 is disposed on the evaporator 305 near the electric compressor 301. The first fan 308 and the second fan 309 are also a part of the air conditioner 300.

The control device 306 includes a harness 306a and connecting cords 306b, 306c, 306d. The harness 306a passes along the backside of the under cover 101 and is connected to the battery 3b in the forklift truck 3. The control device 306 is fixable on the base plate 102.

The connecting cord 306b is connected to the electric compressor 301, so that the electric compressor 301 is operated by the control device 306 to circulate the refrigerant in the air conditioner 300. The connecting cord 306c is connected to the first fan 308, and the connecting cord 306d is connected to the second fan 309. Outside air is sucked into the top cover 104 from the suction ports 13a, 13b through a first filter 110 and a second filter 111 by the first fan 308 and the second fan 309 that are operated by the control device 306. The first fan 308 supplies the air in the top cover 104 to the condenser 302. The second fan 309 supplies the air in the top cover 104 to the evaporator 305.

As illustrated in FIG. 2, the condenser 302 is fixed to the first case 106. The first fan 308 is accommodated in the first case 106. The evaporator 305 is fixed to the second case 107. The second fan 309 is accommodated in the second case 107. A fan shroud is formed of the first case 106 and the second case 107. The evaporator 305 is accommodated in the third case 108. The first to third cases 106 to 108 are each formed in a rectangular parallelepiped shape. The first case 106 and the second case 107 have the same shape and are smaller than the third case 108. The first to third cases 106 to 108 also correspond to a part of the housing 100. The first case 106 is made of metal. The second case 107 is made of metal. The third case 108 is made of resin. The first case 106 and the second case 107, for example, are made of stainless steel.

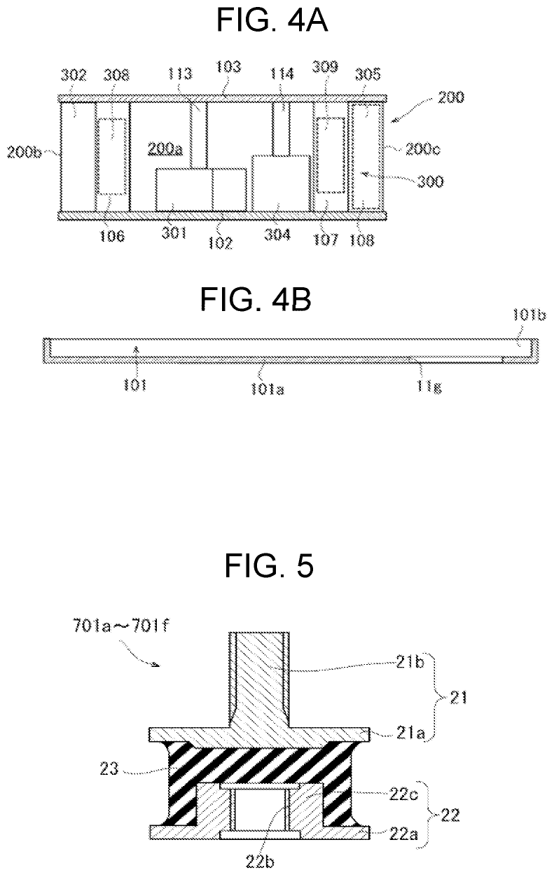

As illustrated in FIG. 3 and FIG. 4, the first case 106 in which the first fan 308 is accommodated, the electric compressor 301, the accumulator 304, the second case 107 in which the second fan 309 is accommodated, and the control device 306 are fixed to a top surface of the base plate 102 with the bolts or the like, which are not illustrated. After this, the electric compressor 301, the condenser 302, the expansion valve 303, the accumulator 304, and the evaporator 305 are connected by the pipes 307, and the refrigerant is sealed therein. In addition, the upper plate 103 is fixed to the first case 106 and the second case 107 with bolts or the like, which are not illustrated.

Then, a first collar 113 and a second collar 114 each having a cylindrical shape are formed from the same cylindrical member. The first collar 113 is disposed between the electric compressor 301 and the upper plate 103 in contact with the electric compressor 301 and the upper plate 103. The second collar 114 is disposed between the accumulator 304 and the upper plate 103 in contact with the accumulator 304 and the upper plate 103. Here, the first collar 113 and the second collar 114 are disposed so that the center of gravity of the electric compressor 301 is located on an extension of the first collar 113 and the center of gravity of the accumulator 304 is located on an extension of the second collar 114. Then, as illustrated in FIG. 4, the base plate 102, the upper plate 103, and the air conditioner 300 are integrated to form a structure 200.

This structure 200, on the sides thereof, has a first opening 200a facing the suction ports 13a, 13b in the top cover 104, a second opening 200b being adjacent to the first opening 200a and facing the heat releasing port 13c, and a third opening 200c being adjacent to the first opening 200a and located on the opposite side of the second opening 200b. The condenser 302 is exposed from the second opening 200b. The evaporator 305 is exposed from the third opening 200c.

As illustrated in FIG. 2, the cold air guiding portion 500 is formed of an inner surface of the top cover 104, in particular, an inner surface of the inclined plate 104c, the two ventilation ports 11g, 11h of the under cover 101, two shades 501, and two punkah-louvers 502. The shades 501 are each fixed around a corresponding one of the ventilation ports 11g, 11h in the under cover 101 together with the punkah-louver 502 with bolts, which are not illustrated, so as to face the third case 108 in which the evaporator 305 is accommodated.

Each of the shades 501 includes a cylindrical portion 501a that is formed in a cylindrical shape extending in a vertical axial direction of the shade 501, and an eaves portion 501b that is formed in an arc shape integrally with the cylindrical portion 501a in an upper portion of the shade 501 in the axial direction. The outer surface of each of the eaves portion 501b faces the evaporator 305 and causes the cold air to detour into the cylindrical portion 501a when the cold air sent from the evaporator 305 blows onto the outer surface.

Each of the punkah-louvers 502 is disposed in a lower portion of the cylindrical portion 501a of a corresponding one of the shades 501 in the axial direction thereof. An air outlet of each of the punkah-louvers 502 is turned, and the cold air is sent to the driver from the air outlet of the punkah-louver 502.

The unit cooler 1 is assembled to the forklift truck 3 by a fastening means 700 and fixed to the forklift truck 3. The fastening means 700 includes six fastening members 701a to 701f, two under rails 702 each formed in a U-shape with corners at right angles when viewed in a cross section, a plurality of bolts 703, and a plurality of nuts 704.

The fastening members 701a to 701f, as illustrated in FIG. 5, are each formed of a first member 21, a second member 22, and a middle member 23. The first member 21 includes a circular plate portion 21a having a circular plate shape and an external screw portion 21b that is integrally formed with the circular plate portion 21a and extends in an axial direction perpendicular to the circular plate portion 21a from the center of the circular plate portion 21a. The second member 22 includes a circular plate portion 22a having a circular plate shape and a boss portion 22c that is integrally formed with the circular plate portion 22a and extends in the same direction as a direction in which the external screw portion 21b extends from the center of the circular plate portion 22a and in which an internal screw portion 22b is formed. The external screw portion 21b corresponds to a first screw portion and the internal screw portion 22b corresponds to a second screw portion. The middle member 23 is made of natural rubber having an insulation property and a vibration isolating property. The middle member 23 connects the circular plate portion 21a of the first member 21 to the circular plate portion 22a and the boss portion 22c of the second member 22.

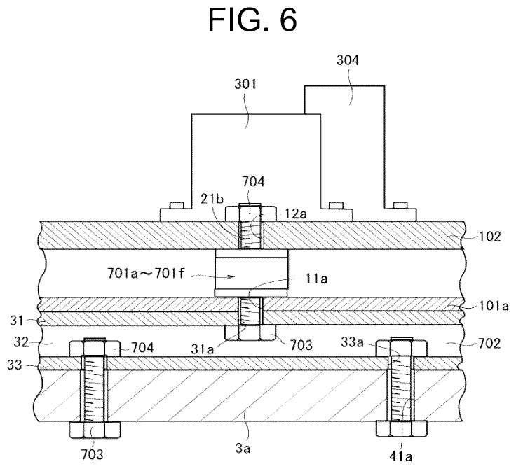

As illustrates in FIG. 2, each of the under rails 702 is formed of an upper rail plate 31, a lower rail plate 33, and a side rail plate 32 connecting the upper rail plate 31 to the lower rail plate 33. Three bolt holes 31a, which are aligned with the bolt holes 11a to 11f of the bottom plate 101a in the under cover 101, extend through the upper rail plate 31. As illustrated in FIG. 6, bolt holes 41a of the suitable number extends vertically through the headguard 3a of the forklift truck 3. A bolt hole 33a, which is aligned with the bolt hole 41a of the headguard 3a, extends through the lower rail plate 33 of the under rails 702. The harness 306a is guided to a rear of the forklift truck 3 along the under rails 702 near the control device 306 on the backside of the under cover 101. In this case, for example, the harness 306a is held to the side rail plate 32 by a holding member, which is not illustrated.

In a case where the unit cooler 1 is fixed to the forklift truck 3, as illustrated in FIG. 4, first, the structure 200 is prepared. In addition, the shades 501 and the punkah-louvers 502 are fixed to the under cover 101. Then, as illustrated in FIG. 6, the two under rails 702 are fixed to the headguard 3a of the forklift truck 3 with the bolts 703 and the nuts 704, and the under cover 101 is mounted on the under rails 702.

In this state, the bolts 703 are inserted into the bolt holes 31a and the bolt holes 11a to 11f and screwed into the internal screw portions 22b of the fastening members 701a to 701f. Here, as illustrated in FIG. 3, the electric compressor 301 in the structure 200 is disposed at a position that is overlapped with an intersection point of a diagonal line connecting the first fastening member 701a and the second fastening member 701f and a diagonal line connecting the first fastening member 701d and the second fastening member 701c. The first fastening member 701a is disposed in the bolt hole 11a of the under cover 101 and the bolt hole 12a of the base plate 102, and the first fastening member 701d is disposed in the bolt hole 11d of the under cover 101 and the bolt hole 12d of the base plate 102. The first fastening members 701a, 701d are disposed with the first fan 308 interposed therebetween. The second fastening member 701c is disposed in the bolt hole 11c of the under cover 101 and the bolt hole 12c of the base plate 102, and the second fastening member 701f is disposed in the bolt hole 11f of the under cover 101 and the bolt hole 12f of the base plate 102. The second fastening members 701c, 701f are disposed with the second fan 309 interposed therebetween.

When the under cover 101 and the under rails 702 are fixed with the fastening members 701a to 701f, the external screw portions 21b of the fastening members 701a to 701f are inserted into the bolt holes 12a to 12f of the base plate 102, and the nuts 704 are screwed onto the external screw portion 21b. Even when the under cover 101 is relatively thin, the under cover 101 is firmly fixed to the headguard 3a.

In addition, as illustrated in FIG. 3, the connecting cords 306b, 306c, 306d of the control device 306 are connected to the electric compressor 301, the first fan 308, and the second fan 309, respectively. Afterwards, sponge rubber 112, which is illustrated in FIG. 2, is placed on the structure 200, the top cover 104 is placed on the under cover 101, and the top cover 104 is fixed on the under cover 101 with a bolt, which is not illustrated. The top cover 104 surrounds the air conditioner 300 together with the under cover 101. The sponge rubber 112 corresponds to an anti-vibration member. The unit cooler 1 of the embodiment is mounted on the headguard 3a of the forklift truck 3 as described above. Note that after all components illustrated in FIG. 2 may be assembled to each other and the under rails 702 may be fixed to the under cover 101, the under rails 702 may be fixed to the headguard 3a of the forklift truck 3.

In this unit cooler 1, in the forklift truck 3 that does not have as many means for reducing vibrations as a passenger car, the electric compressor 301, the first fan 308, and the second fan 309 of the air conditioner 300 are operated by the battery 3b. Thus, warm air is exhausted from the condenser 302 and discharged from the heat releasing port 13c to the outside of the unit cooler 1. Furthermore, cold air flows from the evaporator 305, passes through the shades 501, and is blown out from the punkah-louvers 502 toward the driver M. At this time, the inner surface of the top cover 104, in particular, the inner surface of the inclined plate 104c suitably rectifies the cold air toward the punkah-louvers 502. The driver M may change the direction in which the cold air flows out of the punkah-louvers 502 as desired, such as toward the base of the driver M's neck, by changing the direction of the air outlet of each of the punkah-louvers 502.

Also, in this unit cooler 1, the housing 100 includes the base plate 102 and the upper plate 103, which form the structure 200 together. The first case 106 in which the first fan 308 of the air conditioner 300 is accommodated and the second case 107 in which the second fan 309 is accommodated are located between the base plate 102 and the upper plate 103 and fixed to the base plate 102 and the upper plate 103. Furthermore, the electric compressor 301 of the air conditioner 300 is disposed between the base plate 102 and the upper plate 103 and between the first fan 308 and the second fan 309. The structure 200 has, on the sides thereof, the first opening 200a, the second opening 200b, and the third opening 200c. The air conditioner 300 sucks in the outside air through the first opening 200a, exhausts the warm air through the second opening 200b, and blows the cold air through the third opening 200c. Thus, the air conditioner 300 is integrated with the structure 200, so that the air conditioner 300 is less likely to vibrate while the forklift truck 3 travels and operates.

In particular, in this unit cooler 1, the electric compressor 301 and the base plate 102 are fixed to each other with the fastening members, and the first collar 113 is disposed between the electric compressor 301 and the upper plate 103. The first collar 113 is in contact with the electric compressor 301 and the upper plate 103 and positioned on the extension of the center of gravity of the electric compressor 301. Thus, there is no gap between the electric compressor 301 and the upper plate 103, so that the structure 200 integrates more closely.

In addition, in this unit cooler 1, the accumulator 304 in the air conditioner 300 and the base plate 102 are fixed with the fastening members, and the second collar 114 is disposed between the accumulator 304 and the upper plate 103. The second collar 114 is in contact with the accumulator 304 and the upper plate 103 and positioned on the extension of the center of gravity of the accumulator 304. Thus, there is no gap between the accumulator 304 and the upper plate 103, so that the structure 200 integrates more closely.

Furthermore, in this unit cooler 1, the first case 106 in which the first fan 308 is accommodated is fixed to one ends of the base plate 102 and the upper plate 103, and the second case 107 in which the second fan 309 is accommodated is fixed to the other ends of the base plate 102 and the upper plate 103. Also, the upper plate 103 is located opposite the base plate 102 across the first fan 308 and the second fan 309, and the base plate 102 and the under cover 101 that is disposed under the base plate 102 are fixed with the fastening members 701a to 701f. The first fastening members 701a, 701d are disposed with the first fan 308 interposed therebetween, and the second fastening members 701c and 701f are disposed with the second fan 309 interposed therebetween. Then, the electric compressor 301 is disposed at a position that is overlapped with the intersection point of the diagonal line connecting the first fastening member 701a and the second fastening member 701f and the diagonal line connecting the first fastening member 701d and the second fastening member 701c. Thus, the electric compressor 301, which is the most massive in the air conditioner 300, is evenly supported by the four first and second fastening members 701a, 701d, 701c, 701f, so that the vibrations of the electric compressor 3001 is easily suppressed.

In addition, in this unit cooler 1, the first fan 308 is disposed between the condenser 302 and the electric compressor 301, and the second fan 309 is disposed between the evaporator 305 and the accumulator 304. With this arrangement, the first fan 308 and the second fan 309 are accommodated in the structure 200, so that the structure 200 becomes more compact and integrates more closely. For this reason, while the forklift truck 3 travels or operates, the air conditioner 300 is less likely to vibrate.

Therefore, this unit cooler 1 may send the cold air to the driver M of the forklift truck 3 and is superior in vibration resistance and impact resistance.

Also, in this unit cooler 1, each of the fastening members 701a to 701f includes the middle member 23, and the middle member 23 has the vibration isolating property. This suppresses that the vibrations generated while the forklift truck 3 travels or operates are transmitted to the air conditioner 300 on the base plate 102 to reduce failures of the air conditioner 300, and this absorbs the vibrations of the air conditioner 300 to also contribute to quietness. The sponge rubber 112 that is disposed between the upper plate 103 and the top cover 104 also contributes to this quietness.

Furthermore, in this unit cooler 1, the first member 21 of each of the fastening members 701a to 701f is fixed to the base plate 102 to the top surface of which the air conditioner 300 is fixed. The second member 22 of each of the fastening members 701a to 701f is fixed to the under rails 702 with the under cover 101 interposed therebetween. The under rails 702 are fixed to the headguard 3a of the forklift truck 3. The middle member 23 connects the first member 21 to the second member 22 and has the insulation property. For this reason, even in a case of an electric leakage from the air conditioner 300, the electric current may flow only to the base plate 102 and the first member 21, and does not flow to the middle member 23, the second member 22, and the forklift truck 3.

Also, in this forklift truck 3, as illustrated in FIG. 1, the suction ports 13a, 13b of the unit cooler 1 are located above the headguard 3a, so that noise from the unit cooler 1 hardly disturbs the driver M. In addition, the suction ports 13a, 13b of the unit cooler 1 are located on a left end side of the headguard 3a, so that the first filter 110 and the second filter 111 are easily maintained or inspected.

Furthermore, in this forklift truck 3, the unit cooler 1 is formed in a rectangular shape having longitudinal sides extending in a front-rear direction, the unit cooler 1 is low in height, and the heat releasing port 13c is located at the front end of the headguard 3a, so that the warm air does not blow onto the driver M.

Moreover, by removing the bolt 703 and the nut 704 and performing the above operations in reverse, this unit cooler 1 may be mounted on other industrial vehicles.

Although the present invention has been described above based on the embodiment, the present invention is not limited to the embodiment and may be modified as appropriate within a gist of the present invention.

For example, the unit cooler of the present invention may be used in an electric forklift truck of a counter type, a picking type, a 3-way type, or a refrigerator-freezer type, and may be widely used in industrial vehicles such as various engine forklift trucks, transportation equipment, or towing trucks.

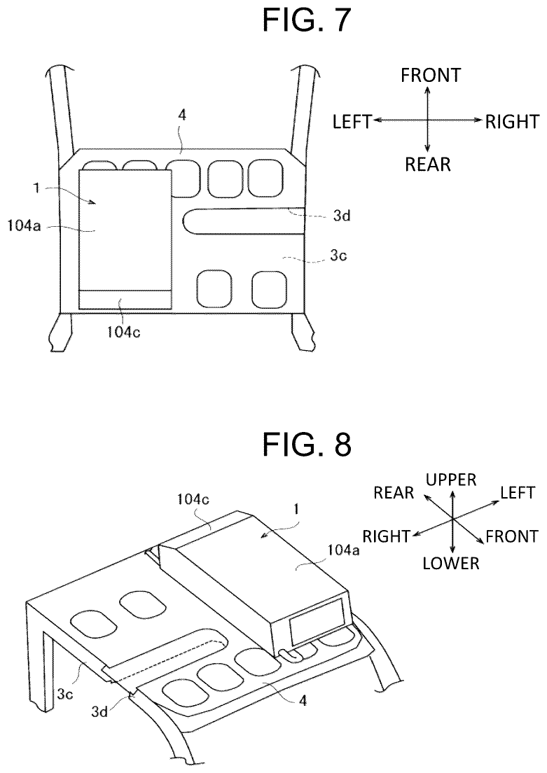

For example, in the counter type electric forklift truck, as illustrated in FIG. 7 and FIG. 8, a cutout 3d for hanging the battery may be formed in the headguard 3c. In order to prevent the unit cooler 1 from overlapping with the cutout 3d, the condenser 302 and the evaporator 305, which are relatively large components in the refrigeration cycle, are positioned at both ends of the unit cooler 1 with their long sides aligned with the short sides of the unit cooler 1, and the other components forming the refrigeration cycle, such as the electric compressor 301, the expansion valve 303, or the accumulator 304 are accommodated between the condenser 302 and the evaporator 305. Thus, these components forming the refrigeration cycle are unitized. In this case, since the unit cooler 1 of the embodiment is formed in the rectangular shape having the longitudinal sides extending in the front-rear direction, the unit cooler 1 may be mounted on the left side of the cutout 3d, that is, the unit cooler 1 may be mounted so as to avoid the cutout 3d. Even when a cover 4 made of transparent resin is disposed on the headguard 3c, the unit cooler 1 is miniaturized so as not to cover the whole cover 4, so that the unit cooler 1 does not interfere with the diagonal upper field of vision of the driver M.

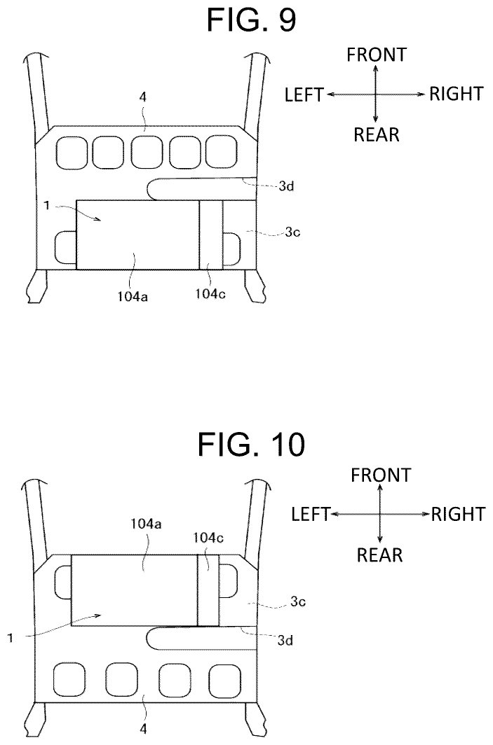

In addition, the mounted state of this unit cooler 1 is not limited to one in which the unit cooler 1 is mounted on the headguard 3c so as to extend in a front-rear direction of the headguard 3c. For example, as illustrated in FIG. 9, this unit cooler 1 may be mounted behind the cutout 3d so as to extend in a left-right direction of the headguard 3c. Alternately, as illustrated in FIG. 10, this unit cooler 1 may be mounted in front of the cutout 3d so as to extend in the left-right direction of the headguard 3c. In these cases, it is determined as desired whether the heat releasing port 13c and the inclined plate 104c are located on the left side or the right side of the headguard 3c.

The first collar 113 and the second collar 114 of the embodiment may be respectively fixed to the electric compressor 301 and the accumulator 304 with the bolt or the like and may be fixed to the upper plate 103 with the bolt or the like.

The anti-vibration member of the unit cooler in the present invention is not limited to the fastening members 701a to 701f described above. The anti-vibration member of the unit cooler in the present invention may be the first member or the second member having the external screw portion or having the internal screw portion.

### INDUSTRIAL APPLICABILITY

The present invention is applicable to a unit cooler mountable on industrial vehicles or the like as an option.

### REFERENCE SIGNS LIST

100 housing
101 under cover
102 base plate
103 upper plate
104 top cover
113 first collar
114 second collar
300 air conditioner
301 electric compressor
302 condenser
303 expansion valve (decompression device)
304 accumulator
305 evaporator
307 pipe
308 first fan
309 second fan
701a to 701f fastening members (701a, 701d first fastening members; 701c, 701f second fastening members)

1. A unit cooler comprising:
a housing; and
an air conditioner that is accommodated in the housing and forms a refrigeration cycle, the air conditioner cooling air and supplying the air to an outside of the housing, wherein
the housing has:
a base plate on which the air conditioner is mounted;
an under cover that is disposed under the base plate;
a top cover that is fixed to the under cover and surrounds the air conditioner together with the under cover; and
an upper plate that is disposed between the top cover and the base plate,
the air conditioner has an electric compressor, a condenser, a decompression device, an evaporator, a pipe through which a refrigerant flows, a first fan that sends air to the condenser, and a second fan that sends air to the evaporator,
the first fan and the second fan are disposed between the base plate and the upper plate and fixed to the base plate and the upper plate, and
the electric compressor is disposed between the base plate and the upper plate and between the first fan and the second fan.

2. The unit cooler according to claim 1, wherein
the electric compressor and the base plate are fixed with a fastening member,
a first collar is disposed between the electric compressor and the upper plate in contact with the electric compressor and the upper plate, and
the first collar is positioned on an extension of a center of gravity of the electric compressor.

3. The unit cooler according to claim 1, wherein
the air conditioner has an accumulator,
the accumulator and the base plate are fixed with a fastening member,
a second collar is disposed between the accumulator and the upper plate in contact with the accumulator and the upper plate, and
the second collar is positioned on an extension of a center of gravity of the accumulator.

4. The unit cooler according to claim 1, wherein
the housing has a first case in which the first fan is accommodated and a second case in which the second fan is accommodated, the first case and the second case being made of metal,
the first fan adjacent to the condenser is fixed to one ends of the base plate and the upper plate through the first case,
the second fan adjacent to the evaporator is fixed to the other ends of the base plate and the upper plate through the second case,
the upper plate is located oppose to the base plate across the first fan and the second fan,
the base plate and the under cover are fixed with a fastening member,
the fastening member includes:
a pair of first fastening members that is disposed with the first fan interposed between the first fastening members; and
a pair of second fastening members that is disposed with the second fan interposed between the second fastening members, and
the electric compressor is disposed at a position that is overlapped with an intersection point of diagonal lines connecting the first fastening members and the second fastening members.
